(19) United States
(12) Patent Application Publication
(10) Pub. No.: US 2002/0186375 A1
(43) Pub. Date: Dec. 12, 2002

(54) Device and methods for detecting samples in a flow cytometer independent of variations in fluorescence polarization

(76) Inventors: Charles L. Asbury, Seattle, WA (US); Jeanne L. Uy, Seattle, WA (US); Gerrit van den Engh, Seattle, WA (US)

Correspondence Address: Delbet J. Barnard, BARNARD & PAULY, P.S., P.O. Box 58888, Seattle, WA, 98138-1888, US

(21) Appl. No.: 09/847,645

(22) Filed: May 1, 2001

(51) Int. Cl. G01N 21/00

(52) U.S. Cl. 356/440

(57) ABSTRACT

The invention provides a sample detection apparatus, including a polarized radiation source, flow chamber and signal detector, the flow chamber placed to contact polarized radiation from the polarized radiation source, the signal detector is placed to selectively detect radiation propagated from the flow chamber at about 54.7 degrees from the direction of polarization of the contacted polarized radiation. Also provided is a method of detecting fluorescent intensity for a sample in a flow cytometer independent of anisotropic radiation emission. The method includes the steps of: (a) contacting a sample in a flow cytometer with polarized radiation; and (b) detecting radiation emitted by the sample at about 54.7 degrees with respect to the direction of polarization of the polarized radiation at the point of sample contact.

This invention was made with government support under grant number T32 GM00035-05 awarded by the National Institutes of Health and grant number BIR 9214821 awarded by the National Science Foundation. The United States Government has certain rights in this invention.

### BACKGROUND OF THE INVENTION

This invention relates generally to flow cytometry and, more specifically, to devices and methods for detection of flow cytometry samples.

Flow cytometry is a valuable method for the analysis and isolation of biological particles such as cells and constituent molecules. As such it has a wide range of diagnostic and therapeutic applications. The method utilizes a fluid stream to linearly segregate particles such that they can pass, single file, through a detection apparatus. Individual cells can be distinguished according to their location in the fluid stream and the presence of detectable markers. Thus, a flow cytometer can be used to produce a diagnostic profile of a population of biological particles. For example, flow cytometry has been used to measure the decline or maintenance of immune cells during the course of treatment for HIV infection and to determine the presence or absence of tumor cells for prognosis and diagnosis of cancer patients.

Isolation of biological particles has been achieved by adding a sorting or collection capability to flow cytometers. Particles in a segregated stream, detected as having one or more desired characteristics, are individually isolated from the sample stream by mechanical or electrical removal. This method of flow sorting has been used to separate sperm bearing X and Y chromosomes for animal breeding, to sort chromosomes for genetic analysis, to isolate cells bearing specific antigens and to identify new organisms from complex biological populations. Although sorting capability can slow down the rate of sample analysis by a cytometer, cell sorters can be operated at rates allowing sorting of greater than 100,000 events per second.

A majority of flow cytometry methods employ fluorescent detection of particles. In a few cases the intrinsic fluorescence of a particle can be used as a basis of detection. A more widely employed method is to detect a fluorescent label that binds to a specific molecule associated with a particle. For example, a cell expressing a specific antigen on its surface can be distinguished from non-antigen bearing cells in the same mixture using a flow cytometer. Specifically, the cell mixture can be incubated with a detectable antibody that binds specifically to the antigen and the mixture can be subsequently analyzed with a flow cytometer to uniquely identify the labeled cell. A sorting capability can further allow the labeled cell to be isolated from the mixture for therapeutic manipulation or further diagnostic analysis.

In many cases it would also be useful to know how many molecules are present on, or in, each cell-in a mixture. The number of labeled molecules associated with a cell can be diagnostic of a response of the cell to various conditions such as disease state or exposure to a therapeutic compound. For example, specific immune cells present in response to various disease states can be distinguished based on the number of cell surface markers present. Thus, one goal of flow cytometry for both analytical and sorting applications is quantitative flow cytometry.

Quantitative flow cytometry refers to methods for correlating the intensity of detected signal with the quantity of labeled molecules on the particle. Quantitation can be achieved for an individual instrument, for example, by calibrating the instrument with optical test materials and producing empirical calibration curves for each new lot of reagents used. Standardized measurements are desired for accuracy and quality assurance in diagnosis and prognosis of human disease. However, expansion of quantitative flow cytometry to allow standardized measurements between instruments and labs has not been achieved despite attempts by a number of national and international programs. Variability between instruments and methods has been one drawback to standardization of quantitative flow cytometry between laboratories which could achieve the accuracy required for most clinical applications.

Thus, there exists a need for methods to standardize fluorescence measurements in flow cytometry. The present invention satisfies this need and provides related advantages as well.

### SUMMARY OF THE INVENTION

The invention provides a sample detection apparatus, including a polarized radiation source, flow chamber and signal detector, the flow chamber placed to contact polarized radiation from the polarized radiation source, the signal detector is placed to selectively detect radiation propagated from the flow chamber at about 54.7 degrees from the direction of polarization of the contacted polarized radiation. Also provided is a method of detecting fluorescent intensity for a sample in a flow cytometer independent of anisotropic radiation emission. The method includes the steps of: (a) contacting a sample in a flow cytometer with polarized radiation; and (b) detecting radiation emitted by the sample at about 54.7 degrees with respect to the direction of polarization of the polarized radiation at the point of sample contact.

### BRIEF DESCRIPTION OF THE DRAWINGS

FIG. 1 shows devices that detect radiation at an anisotropic-independent angle. Part A shows a device having a detector that selectively collects radiation that is emitted in a direction about 54.7° from the direction of irradiation polarization. Part B shows a device having a polarizer with pass-axis at about 54.7° from the direction of radiation polarization placed in front of a detector. Part C shows a device having orthogonal geometry and a detector that selectively collects radiation that is emitted in a direction about 54.7° from the direction of irradiation polarization.

FIG. 2 shows polar plots of predicted fluorescence intensity variations. Intensity is represented by the radial distance from the origin and the angle is measured clockwise from the vertical axis. Plot A shows variation of fluorescence intensity with polarization angle. Plot B shows the variation of fluorescence intensity with angle of emission. The isotropic case produces the circular curve and the maximally anisotropic case produces the bean shaped curve. The perfectly polarized case is shown as shaded gray.

FIG. 3 shows a diagram of signal collection optics in part A and polarizer in part B.

FIG. 4 shows analysis of raw data from a polarization measurement. A bivariate dot-plot of 40,000 individual bead measurements is shown in gray. The black line indicates peak values chosen after smoothing the intensity distribution.

FIG. 5 shows polar plots of relative intensity versus polarization angle for bead scatter. Dots show intensity values measured at each angle. Solid lines show the best-fit of Equation 2 to the data points.

FIG. 6 shows polar plots of relative intensity versus polarization angle for bead fluorescence. Measured data and fitted curves are represented as in FIG. 5.

### DETAILED DESCRIPTION OF THE INVENTION

This invention provides a flow cytometer with detection optics oriented to measure radiation scatter intensity or fluorescence emission intensity independently of their degree of anisotropy. The intensity of scatter and emission for particles measured in a flow cytometer is generally dependent on the angle of detection and the degree of anisotropy of the radiation emitted or scattered by the particle. This anisotropic emission can present a problem for standardization or calibration of quantitative measurements. However, intensity of scattered and emitted radiation is independent of anisotropic radiation emission when detected at an angle of about 54.7° from the direction of the excitation polarization. An advantage of this invention is that it provides a standardized observation direction and therefore makes it possible to compare the intensity of flow cytometry measurements with an objective standardized reference source.

In one embodiment the invention provides a method of detecting emitted or scattered radiation from a sample that is independent of intensity variations due to anisotropic radiation emission. Specifically, the invention provides a method of detecting radiation from a sample at an angle of about 54.7° from the direction of polarization. Additionally, the dependence of intensity on polarization angle and anisotropic radiation emission can be predicted for particles in a sample stream, for example, in a flow cytometer. Therefore, the invention also provides methods for determining a standardized intensity value based on the optical properties of a cytometer or photophysical properties of a particle. Accordingly, another advantage of the methods of the invention is that they allow determination of a standardized intensity value that can be compared between instruments as well as between fluorophores.

As used herein, the term “flow cytometer” is intended to mean a device or apparatus having particles aligned in a sample stream such that the particles individually enter a zone of detection. A sample stream can include any mobile phase that passes particles in single file including, for example, a fluid stream or fluid jet. The term is intended to include any particle including one or more molecules. A particle including one molecule can be, for example, a fluorophore or a macromolecule such as a polynucleotide, polypeptide, or other organic or biological polymer. A particle including more than one molecule can be, for example, a cell, molecular complex or bead.

As used herein, the term “polarized,” when used in reference to radiation, is intended to mean electromagnetic radiation having an electric field vector biased toward a uniform direction or enriched in one direction. The direction of polarization of electromagnetic radiation refers to the direction of the electric field vector relative to the direction of propagation of the electromagnetic radiation. A uniform electric field vector can be linearly fixed with respect to the direction of propagation or can rotate about the direction of propagation circularly or elliptically.

As used herein, the term “polarized radiation source” is intended to mean a means for producing or selectively propagating electromagnetic radiation having an electric field vector biased toward a uniform direction or enriched in one direction. The term is intended to include all illumination sources including, for example, those producing electromagnetic radiation in the ultraviolet, visible and/or infrared regions of the spectrum. A radiation source can include, for example, a lamp such as an arc lamp or quartz halogen lamp, or a laser such as an ion laser, dye laser or diode laser.

As used herein, the term “signal detector” is intended to mean a device or apparatus that converts the energy of contacted photons into an electrical response. A signal detector can produce an electric current in response to impinging photons, for example, as in a photodiode or photomultiplier tube. A signal detector can also accumulate charge in response to impinging photons.

As used herein, the term “flow chamber” is intended to mean an apparatus that can contain a sample stream such that radiation emitted or scattered by a particle in the sample stream can be detected.

As used herein, the term “selective” or “selectively,” when used in reference to detection of radiation, is intended to mean preferential detection of radiation having a particular property. The term can include detection of radiation having a particular property due to total or partial rejection of radiation having one or more other properties. The property of radiation can include, for example, direction of propagation or direction of polarization.

As used herein, the term “sample” is intended to mean a molecule, particle or mixture of molecules or particles. The term can include, for example, one or more particles suspended or solubilized in a liquid phase. As used herein, the term “sample stream” refers to particles that have a net directional flow. Particles having a net direction or flow can be contained, for example, in a mobile liquid phase. A mobile liquid phase can be in a state characterized, for example, as having laminar flow, sheath flow, or streamline flow. Alternatively, the liquid phase can be stationary and the particles can move through the liquid phase due to, for example, extrinsic force or pressure.

As used herein, the term “degree of polarization” is intended to mean the value P in the equation P=((α−β)/(α+β)), where α is the intensity of detected irradiation having an electric field vector parallel to the electric field vector of radiation from a radiation source and β is the intensity of detected irradiation having an electric field vector orthogonal to the electric field vector of radiation from a radiation source. Scattered light can have a degree of polarization that is between −1 and +1. Irradiation produced by emission from a fluorophore excited by polarized light can have a degree of polarization that is greater than 0 and less than or equal to 0.5.

The invention provides a sample detection apparatus. The apparatus consists of a polarized radiation source, flow chamber and signal detector, the flow chamber being placed to contact polarized radiation from the polarized radiation source, the signal detector being placed to selectively detect radiation propagated from the flow chamber at about 54.7 degrees from the direction of polarization of the contacted polarized radiation. Also provided is a flow cytometer having the sample detection apparatus. The flow cytometer consists of a polarized radiation source, flow chamber and signal detector, the flow chamber being placed to contact polarized radiation from the polarized radiation source, the signal detector being placed to selectively detect radiation propagated from the flow chamber at about 54.7 degrees from the direction of polarization of the contacted polarized radiation. The sample detection apparatus can be placed in any flow cytometer to provide detection of emitted or scattered radiation intensity that is independent of anisotropic radiation emission.

When a fluorophore or other molecule emits fluorescence, it emits radiation in all directions. Anisotropic radiation emission refers to a difference in the amount of radiation emitted in different directions when fluorescence is induced by a polarized source. In contrast, isotropic emission refers to identical amounts of radiation emitted in all directions. Whether a fluorophore produces isotropic or anisotropic emission when irradiated by polarized radiation depends upon intrinsic properties of the fluorophore and mobility of the fluorophore. Further, the degree of anisotropic radiation emission can vary among anisotropic fluorophores, also due to intrinsic properties of the fluorophores or their mobility. As described below, fluorescence intensity measured at an arbitrarily chosen polarization angle, or at an arbitrary observation angle, can therefore depend on the degree of anisotropy in the distribution of emitting dipoles.

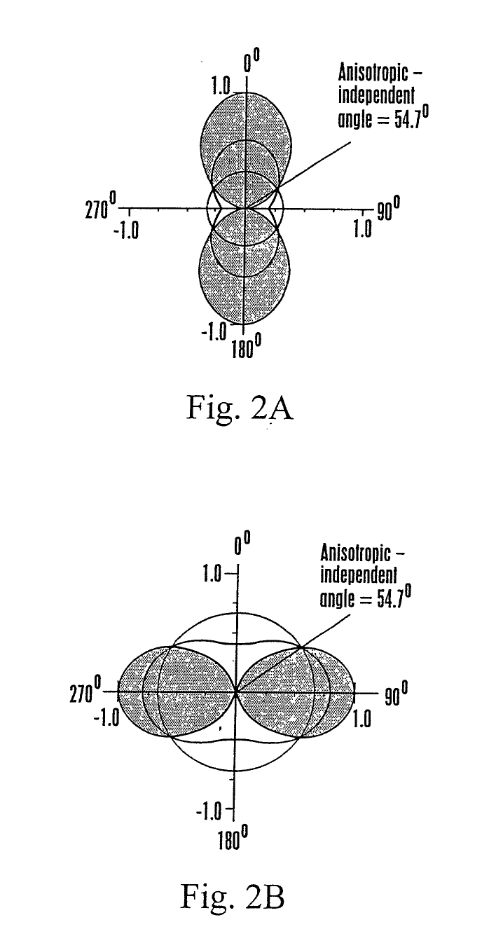

Fluorescence intensity measured for an anisotropic sample can change with polarization angle or angle of emission such that intensities measured for the same sample at different angles of detection or for different samples having different degrees of anisotropic radiation emission, can be different. These differences are shown for the extreme case in FIG. 2 where comparison of the intensity distribution for emission from an isotropic fluorophore is compared to the intensity distribution for emission from a maximally anisotropic fluorophore. As shown in FIG. 2, there is one region where intensity is independent of anisotropic radiation emission. This region is at an angle about 54.7° from the direction of polarization for radiation contacting the fluorophore. Thus, for a sample irradiated by a linearly polarized light source, intensity measurements can be made that are independent of anisotropic radiation emission when either a detector selectively collects radiation that is emitted in a direction of about 54.7° from the direction of irradiation polarization or a polarizer with pass-axis at about 54.7° from the direction of radiation polarization is placed in front of a detector. Measurements made in the above described geometries, are referred to herein as measurements at an anisotropic-independent angle.

One skilled in the art will recognize that small variations in the angle of detection can be accommodated by the invention so long as the difference between the intensities measured at the variated angle and 54.7° under otherwise similar conditions are indistinguishable or statistically meaningless. For example, the range of angles that provide anisotropic-independent detection for two samples can increase as the differences in the degrees of anisotropic radiation emission between the two samples decrease. One skilled in the art can determine an appropriate range for relative difference in intensities determined for anisotropic-independent detection as it can vary from 54.7° using equation 1 and/or plots similar to those shown in FIG. 2 as described below. One skilled in the art will recognize that an angle that is about 54.7° can include an angle in the range of about 53° to about 57°, for example, when resolution between detected intensities is relatively low. As resolution increases about 54.7° can include a narrower range of angles such as about 54° to about 56°, or about 54.5° to about 55°.

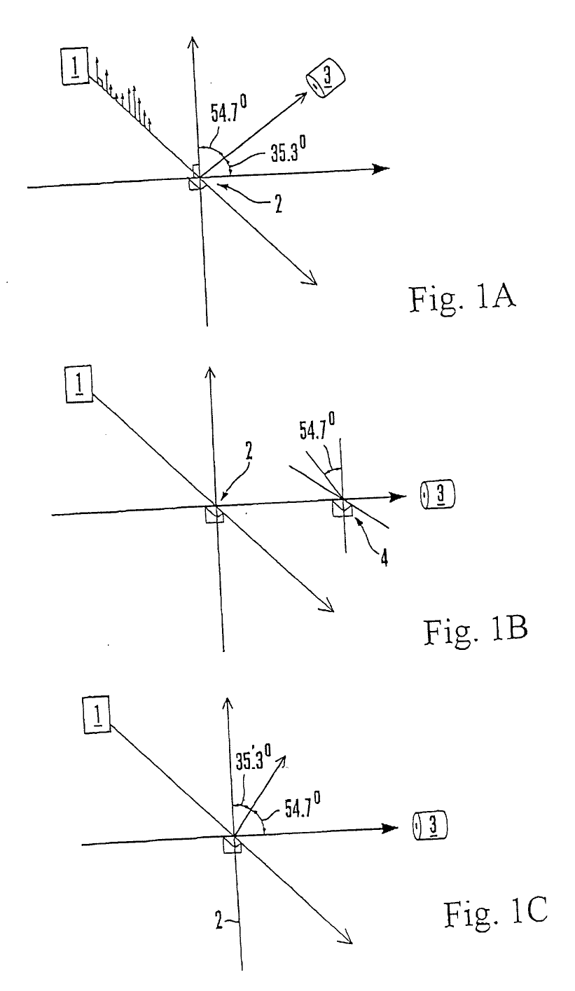

The invention provides a sample detection apparatus having a polarized light source and a signal detector at about 54.7 degrees with respect to the direction of polarization of the irradiation at the point of observation. A device having a detector that selectively collects radiation emitted in a direction about 54.7° from the direction of irradiation polarization is shown in FIG. 1A. The device in FIG. A has a radiation source 1 which produces radiation that is linearly polarized along the Z axis. A detector 3 is placed to selectively detect radiation emitted or scattered from a sample 2 located at the origin of the three orthogonal axes that is irradiated by the radiation source.

A radiation source of the invention can be any source that produces linearly-polarized radiation. A radiation source useful in the invention includes, for example, a lamp such as an arc lamp, quartz halogen lamp, or deuterium lamp. Arc lamps include for example, mercury arc lamps or xenon arc lamps. One skilled in the art will know that an appropriate lamp can be chosen based on a variety of factors including, for example, average radiance across the spectrum, radiance in specific regions of the spectrum, presence of spectral lines, radiance at spectral lines, or arc size. A radiation source can also be a laser including, for example, an ion laser such as argon ion or krypton ion laser, Helium neon laser, helium cadmium laser, dye laser, YAG laser or diode laser. One skilled in the art can choose an appropriate laser or lamp according to desired properties such as those described above or in Shapiro, Practical flow cytometry, 3^{rd} Ed. Wiley-Liss, New York (1995).

A sample of the invention can include a particle or mixture of particles in a liquid phase. A sample detection apparatus of the invention can have a sample contained in a liquid stream where the particles have a net directional flow, for example, along the Z axis of FIGS. 1A and 1B. One skilled in the art will recognize that the trajectory of the liquid stream in FIGS. 1A and 1B can be altered from that shown while still achieving detection at an anisotropic-independent angle. The liquid stream can be contained in a capillary. or in a stream in air system. A particle of the sample can be microscopic particles such as cells, subcellular compartments such as organelles, or large macromolecules such as ribosomes or chromosomes. Particles that can be used in the invention also include submicroscopic particles such as proteins, nucleic acids, other organic or biological polymers or micelles. Manipulation and detection of samples in liquid streams can be performed as described, for example, in Shapiro, supra.

A detector that can be used in the invention includes any device that converts the energy of impinging radiation into a signal that can be subsequently manipulated or stored to determine the presence or quantity of an irradiated sample. A signal produced by a detector can be, for example, an electrical response. A signal detector can produce an electric current in response to impinging photons as occurs, for example, in a photodiode or photomultiplier tube. A signal detector can also accumulate charge in response to impinging photons as occurs, for example, in a charged coupled device. One skilled in the art will be able to choose a detector based on a variety of well known factors including, for example, compatibility with the radiation source used, sensitivity, spectral range of detection and compatibility with data processing devices.

The invention also provides a sample detection apparatus, containing a flow chamber and a polarizer with its pass-axis oriented at about 54.7 degrees with respect to the direction of polarization of a radiation emitted from the flow chamber, the polarizer being placed between the radiation source and a detector. A device having a polarizer with pass-axis at about 54.7° from the direction of radiation polarization placed in front of a detector is shown in FIG. 1B. The device in FIG. 1B has a radiation source 1 which produces radiation, linearly polarized along the Z axis that contacts a sample 2. Radiation emitted from the sample 2, located at the origin of the three orthogonal axes, as fluorescence or scatter, passes through a polarizer 4 to a detector 3. The polarizer 4 has a pass-axis angle of 54.7° from the direction of radiation polarization. The detector 3 is shown orthogonal to the direction of radiation incidence. However, in contrast to the geometry in FIG. 1A, the detector in FIG. 1B can be at any geometry from the direction of radiation polarization or incidence.

A polarizer of the invention can be any material that selectively passes radiation having a uniform electric field vector biased in a uniform direction or enriched in one direction. Examples of polarizers that can be used in the invention include polarization filters such as those having oriented, optically active molecules or polarizing beamsplitters.

An advantage of a device that detects intensity at an anisotropic-independent angle is that intensity is measured independent of polarization effects allowing a standardized intensity to be obtained for comparison between samples having different degrees of anisotropic radiation emission. In contrast, standard cytometers having detectors that are orthogonal to a radiation source detect different intensities depending on the degree of anisotropic radiation emission for each sample. Thus, two samples having the same molar absorption coefficient and fluorescence quantum yield, although having the same theoretical brightness, will yield inconsistent intensities if they have different degrees of anisotropic radiation emission and are measured in the above-described orthogonal arrangement. Additionally, the same detector measuring the same sample from different vantage points can detect different intensities when the sample has an anisotropic distribution of emitting dipoles. Thus, instruments having the same detector can measure different intensities for the same sample if they have different geometries. Detection at an anisotropic-independent angle provides a means to standardize intensity measurements, thereby avoiding differences due to polarization and/or detector geometry.

One skilled in the art will recognize that the device shown in FIG. 1 can be modified such that the geometry of one or more components is changed relative to any other component so long as the detector selectively detects either radiation that is emitted in a direction about 54.7° from the direction of irradiation polarization or radiation passing a polarizer with pass-axis at about 54.7° from the direction of radiation polarization. For example, a prism, mirror, or other light redirecting means can be used to orient components in a manner consistent with the present invention and convenient for a variety of instruments or applications as described below.

The invention also includes a modification of a sample detection apparatus to produce detection at an anisotropic-independent angle. One skilled in the art will be able to modify a sample detection apparatus by routine methods to achieve the geometries described herein. For example, a sample detection apparatus in a flow cytometer can be modified to provide detection at an anisotropic-independent angle. A variety of flow cytometers that can be modified for detection at an anisotropic-independent angle are described, for example, in Shapiro, supra (1995). A common geometry for a flow cytometer detector has the detector, sample trajectory, and radiation source orthogonal to each other in three dimensions. This orthogonal geometry can be easily modified to achieve detection at a anisotropic-independent angle, for example, by swinging the detector relative to the direction of polarization or by rotating the direction of polarization relative to the direction of the detector.

Modifications can be made to a flow cytometer relative to the sample trajectory to achieve the geometries described herein. For example, flow cytometers in which the sample stream is irradiated with radiation having a direction of polarization parallel to the sample trajectory can be modified to detect at a anisotropic-independent angle. Therefore, the invention provides a flow cytometer having a sample stream with a trajectory orthogonal to the irradiation source and parallel to the direction of polarization and a point of observation of the signal detector placed about 54.7 degrees from a line parallel to the trajectory of the sample stream.

Additionally, for a specific example where a flow cytometer in which the sample stream, the main axis of the signal detector and the illumination beam are orthogonal with respect to each other, the direction of polarization of the radiation can be manipulated so that the signal intensity registered by the detector is independent of the degree of anisotropy of emitted radiation. A flow cytometer having this geometry can be modified, for example, such that mirrors or other apparatuses, that direct the irradiation beam towards the sample stream are positioned to turn the beam's direction of polarization 35.3 degrees from a line parallel to the trajectory of the sample stream. Accordingly, a flow cytometer having a sample stream placed to contact polarized radiation from the polarized radiation source and a signal detector placed to selectively detect radiation propagated from the sample stream at about 54.7 degrees from the direction of polarization of the contacted polarized radiation can have a sample stream with a trajectory orthogonal to the polarized radiation source. The sample stream can be orthogonal to the signal detector. Additionally, the polarization direction can be 35.3 degrees from a line parallel to the trajectory of the sample stream.

Similar modifications can be made to any sample detection apparatus. Thus, the invention provides a sample detection apparatus having a sample stream with a trajectory orthogonal to a signal detector and polarized radiation source, wherein the direction of polarization of the irradiation beam is 35.3 degrees from a line parallel to the trajectory of the sample stream. An example of a detection apparatus having the above described geometry is shown in FIG. 1C and includes a sample stream having a trajectory along the Z axis, a radiation source 1 produces radiation that propagates in a direction that is orthogonal to the sample stream trajectory 2. The radiation propagating from the radiation source 1 is linearly polarized at an angle of 35.3° from the Z axis which is parallel to the sample stream trajectory 2. A detector 3 is placed orthogonal to the sample stream trajectory 2 and radiation source to selectively detect radiation emitted or scattered from the sample stream trajectory 2 at an angle of 54.7° from the direction of polarization.

A flow cytometer can also be modified to detect radiation at an anisotropic-independent angle by placing a polarizer between the sample and detector such that radiation having a pass-axis of about 54.7° from the direction of polarization is selectively detected. One skilled in the art can routinely add a polarizer to a cytometer as described in Example I or by other methods well known in the art.

The invention also provides a method of detecting fluorescent intensity for a sample in a flow cytometer independent of anisotropic radiation emission. The method includes the steps of: (a) contacting a sample in a flow cytometer with polarized radiation; and (b) detecting radiation emitted by the sample at about 54.7 degrees with respect to the direction of polarization of the polarized radiation at the point of sample contact.

In addition to measuring intensities at an anisotropic-independent angle, a standardized intensity can also be determined according to the methods of the invention. Therefore, the invention provides a method for determining a standardized fluorescence intensity for a sample in a flow cytometer. The method includes the steps of (a) irradiating a sample with polarized radiation, and (b) detecting intensity of emission at an identified angle of detection-with respect to the direction of polarization of the irradiation, wherein a standardized fluorescence intensity comprises intensity of emission at the identified angle of detection with respect to the direction of polarization of the irradiation.

A standardized fluorescence intensity value is an intensity of fluorescence that can be compared between sample detection apparatuses having different geometries. A standardized fluorescence intensity can be determined, according to any relationship that accurately predicts relative intensity with polarization angle for a given sample. As described in Example I, the dependence of relative intensity on polarization angle for a sample in a flow cytometer can be accurately predicted by the following models. The model is based on the fact that when vertically polarized radiation hits a collection of randomly oriented dye molecules, photoselection occurs. As depicted in FIG. 2, the resulting distribution of excited fluorophores is cylindrically symmetric and it contains many molecules with vertical or near-vertical absorption dipoles. When this collection of molecules emits fluorescence, the distribution of emitting dipoles will also be anisotropic and cylindrically symmetric. Equation 1 provides a relationship between the intensity of fluorescence (I) detected at an angle relative to the direction of laser polarization (η)

I(η)=α*cos² η+β*sin² η (Eqn 1)

where α and β are the intensities measured when the pass-axis is vertical and horizontal, respectively. The total intensity that would be measured without a polarizer is (α+β).

For a fluorophore having maximum possible anisotropic radiation emission, equation 1 can be used to derive equation 2

I(η)∝(⅗)cos² η+(⅕)sin² η (Eqn 2)

as described, for example, in Asbury et al., Cytometry 40:88-101 (2000). For a fluorophore that is completely isotropic, equation-1 can be used to derive equation 3

I(η)∝(⅓)cos² η+(⅓)sin² η=⅓ (Eqn 3)

also described in Asbury et al. (2000), supra. Accordingly, Equations 2 and 3 are specific forms of equation 1. If β=0, Equation 2 describes a source with perfect vertical polarization, for example along the z-axis as shown in FIG. 2. If α=0, the source has perfect horizontal polarization, for example, along the x-axis in FIG. 2.

The variation in fluorescence intensity with polarization angle determined from equations 2 and 3 is shown in FIG. 2A which represents fluorescence intensity as the radial distance from the origin at specific polarization angles. As shown in FIG. 2A, variation of fluorescence intensity with polarization angle for the isotropic case yields a circular curve according to equation 3. For the maximally anisotropic case a bean shaped curve is produced according to equation 2. Comparison of the fluorescence intensity with polarization angle for the isotropic and maximally anisotropic case indicates that intensities will be independent of differences in anisotropic radiation emission of the samples at a polarization angle of 54.7° from the direction of radiation polarization, as indicated by the line identified as the anisotropic-independent angle. One skilled in the art will recognize that according to the symmetry in the relationship of intensity to polarization angle for the two cases plotted in FIG. 2A, an anisotropic-independent angle of about 54.7° is equivalent to about 144.7° when considered in a 180° reference frame and equivalent to about 144.7°, about 234.7° and about 324.7° when considered in a 360° reference frame. The symmetry illustrated in 2 dimensions by the polar plot of FIG. 2A can be extended to 3 dimensions because the anisotropic-independent angle is symmetric with respect to rotation about the laser polarization axis. Thus, the anisotropic-independent angle corresponds to two cones radiating from the angle of polarization at about 54.7° and about 144.7°, respectively. This invention is described in a 90° reference frame, thereby including the above described angles when described in other reference frames.

The mathematics leading to Equations 2 and 3 can also be used to determine how the total fluorescence intensity, measured without a polarizer, varies as the angle of observation is changed. In this case, the symbol η is taken to represent the angle between the detection axis and vertical. The variation of intensity with angle of observation (I_{OA}) for a maximally anisotropic fluorophore is described by equation 4,

I_{OA}(η)=(⅖)cos² η+(⅘)sin² η (Eqn 4)

and for an isotropic fluorophore is described by equation 5,

I_{OA}(η)=(⅔)cos² η+(⅔)sin² η=⅔ (Eqn 5)

The variation in fluorescence intensity with angle of emission is plotted in FIG. 2B. As shown in FIG. 2B, variation of fluorescence intensity with angle of emission for the isotropic case yields a circular curve according to equation 5. For the maximally anisotropic case a bean shaped curve is produced according to equation 4. Comparison of the fluorescence intensity with polarization angle for the isotropic and maximally anisotropic cases indicates that intensities will be independent of differences in anisotropic radiation emission of the samples at an angle of emission of about 54.7° from the direction of radiation polarization, as indicated by the line identified as a anisotropic-independent angle. As described above a anisotropic-independent angle includes equivalent angles identifiable by symmetry from FIG. 2B.

According to the methods of the invention a standardized intensity can be determined for any sample in any flow cytometer. For example, a standardized intensity can be determined for the same sample measured in cytometers having different detector geometries by applying the above models. As demonstrated in Example I, the dependence of intensity on polarization angle or angle of emission can be empirically determined for a sample. The data can be fitted to equation 1 to determine values of α and β. Based on the equation having the α and β values determined for the sample and an intensity measured in a detector at a known angle η, relative intensity values for the sample can be calculated for any angle η. Thus, intensities for a sample measured with detectors having different geometries can be compared and standardized by reference to the appropriate derivative of equation 1. One skilled in the art will recognize that a similar method can be used to determine a standardized intensity for different samples. For example, the standardized intensity values determined as described above, can be compared between different samples by appropriate correlation of intensities with respect to photophysical properties of the samples such as molar absorption coefficient and fluorescence quantum yield.

Therefore, the invention provides a method for determining a standardized fluorescence intensity for a sample in a flow cytometer. The method includes the steps of: (a) determining intensity of radiation emitted from a sample in a flow cytometer at two or more angles with respect to the direction of polarization for a radiation source; (b) determining values of α and β for the sample according to the equation:

I(η)=α*cos² η+β*sin² η,

wherein I(η) is intensity of fluorescence at an angle η relative to the direction of polarization, α is intensity of vertically polarized fluorescence and β is intensity of horizontally polarized fluorescence; and (c) determining fluorescence intensity at a different angle of detection compared to the two or more angles according to the equation, wherein the equation comprises the determined values of α and β.

The invention provides a method for determining that scattered irradiation passes through a filter by determining degree of polarization through a filter, wherein a degree of polarization greater than 0.5 indicates scatter through the filter. As described above, the polarization behaviors of scatter and fluorescence are very different. Specifically, the polarization value, P can not be greater than 0.5 for fluorescent emission, but P can be any value between −1 and +1 for scattered radiation. Therefore, detection of a P value greater than 0.5 for radiation passing through a filter from an irradiated sample indicates passage or leak of scattered irradiation through the filter.

An advantage of using the method to determine that scattered radiation passes through a filter is that an appropriate filter can be chosen for a particular application. One approach is to compare the apparent degree of polarization from a particular irradiated sample using several filters and to identify a trend in scatter blocking ability as described in Example II. A filter can be chosen which passes the most radiation relative to the others, while having a degree of polarization that is indicative of desired scatter blocking ability. A desired scatter blocking ability can be identified as the lowest P value in a set of filters or as a desired P value. A desired P value for fluorescence emitted by a sample can be determined as a P value for radiation emitted from the sample when scattered radiation is effectively blocked as described, for example, in Example II.

The invention also provides a method for determining scatter through a filter by determining apparent polarization direction of light passing through a filter at two laser polarization directions, wherein a change in apparent polarization direction for the two laser polarization directions indicates scatter through the filter. When rotation is in the plane defined by the direction of polarization of the laser and the detection axis, the polarization direction of pure fluorescence will not change, so that any change in the apparent polarization direction indicates that scatter is leaking through the filter. A quantitative measure of laser-blocking efficiency for specific filter combinations can be obtained from such data, thereby allowing objective evaluation of filter sets.

The following examples are intended to illustrate but not limit the present invention.

### EXAMPLE I

### Determination of the Dependence of Fluorescence and Scatter Intensity on Polarization Angle

This example demonstrates methods to determine the effects of anisotropic radiation emission in a flow cytometer. The example also demonstrates that intensity distributions in plots of intensity versus polarization angle closely follow equation 2.

As described below, polarization state was determined by rotating a polarizer in front of a detector. The orientation of the polarizer and the intensity passing the polarizer were recorded simultaneously. The polarizer was rotated during data collection. The distribution of intensity versus polarization angle for a population of particles was obtained. Intensity distributions were plotted in polar coordinates. A curve-fitting procedure was used to calculate the degree of polarization for the population.

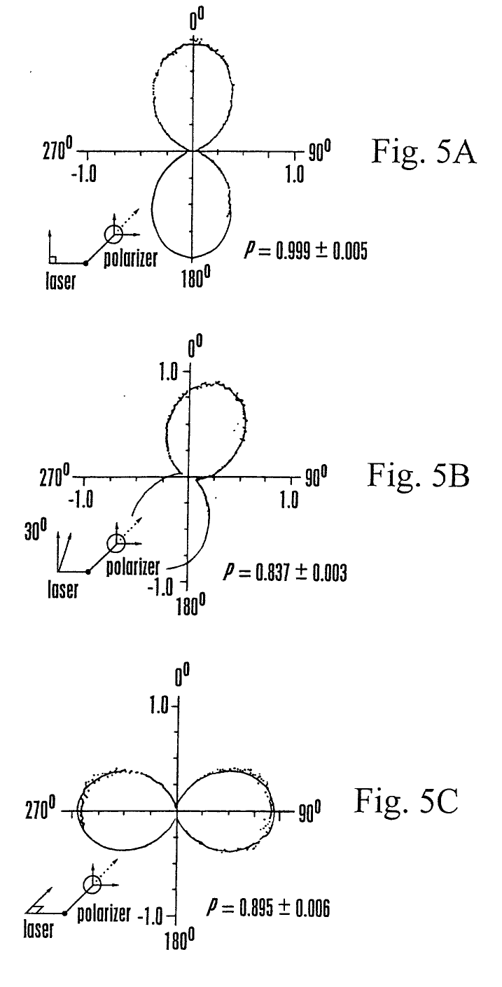

Polar plots of intensity versus polarization angle for light scattered from uniform beads are shown in FIG. 5. The measured intensity distributions followed Equation 2 very closely. Regardless of the direction of polarization of the laser, scattered light exhibited a very high degree of polarization, with values of P greater than 0.83. As shown in FIG. 5A, scatter was perfectly polarized (P˜1.00) when the laser polarization was vertical, indicating that depolarized light from multiple reflections and aperture depolarization made a negligible contribution in this case. When the laser polarization was rotated, these depolarizing effects made a slightly more significant contribution, as indicated by the decrease in the degree of scatter polarization in FIGS. 5B and 5C.

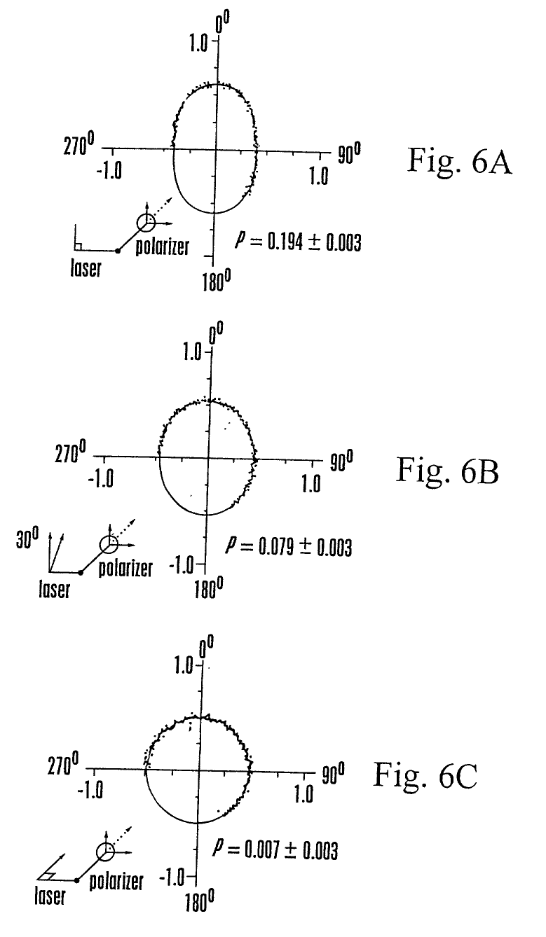

Upon 488-nm excitation, the fluorescence from the beads was moderately polarized with P=0.194±0.003 as shown in FIG. 6A. Repeated measurements (N=28) of bead fluorescence at this excitation wavelength demonstrated excellent reproducibility with average P=0.189, and standard deviation, σₚ=0.011. P values were independent of laser power between 65 and 255 mW and independent of photomultiplier control voltage between 0.2 and 0.6 V. Unlike scatter, the main direction of fluorescence polarization did not rotate when the laser polarization was rotated as shown in FIGS. 6B and 6C. FIG. 6C shows that, only the degree of fluorescence polarization changed, decreasing toward P˜0.00 as the laser polarization became parallel with the detection axis. The degree of fluorescence polarization from these beads depended on the excitation wavelength. Upon UV excitation, bead fluorescence was only weakly polarized at P=0.052±0.002.

The above measurements were made with the flow cytometer described previously in Asbury et al., Cytometry 24:234-242 (1996) and van den Engh et al., Cytometry 10:282-293 (1989) and the following conditions. Fluidic and optical components were mounted on an optical bench, allowing easy access to and modification of the instrument. A 70-μm nozzle operating at 210 kPa (30 psi) produced a jet velocity of ˜20 m/s. Samples were injected into the center of the stream through a PEEK capillary tube (Upchurch, Oak Harbor, Wash.) with an internal diameter. of 250 μm. Two argon lasers were used, which were tuned for multiline UV (model Innova 307;Coherent, Santa Clara, Calif.) and single-line visible excitation (model lnnova 306). Typically, the lasers were adjusted to produce 100 mW or less. Lasers were usually polarized vertically, parallel to the jet, except in a few experiments when the laser polarization was rotated using a half-wave retarder.

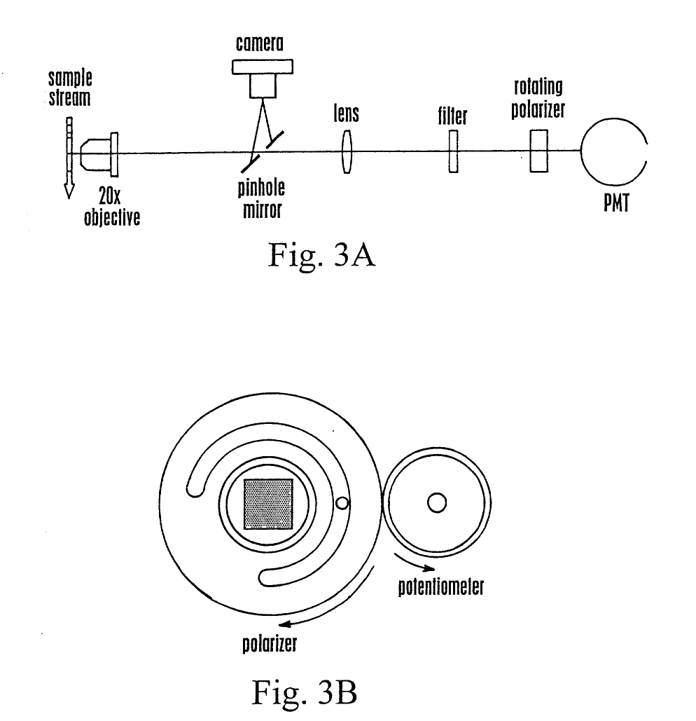

Light emitted from the laser crossing-point was focused onto a pinhole mirror as shown in FIG. 3A using an objective lens with 0.42 NA (20×M Plan Apo, model 378-8042; Mitutoyo, Japan). At this low numerical aperture, aperture depolarization effects are expected to be minimal. The pinhole acted as a spatial filter. Light passing through the pinhole was collimated by a lens (f=75 mm) before passing through color filters and entering the polarizer (described below). Light reflected by the pinhole mirror was imaged onto a CCD camera and displayed on a video monitor, allowing continuous visual inspection of the alignment of stream, laser, and pinhole.

The electronics of the machine have been described in van den Engh et al., (1989) supra. The system can accept up to eight input signals. The inputs can either measure DC levels or pulse heights. Pulsed inputs are filtered using baseline-restoration circuitry before analog-to-digital (A/D) conversion to remove background from the pulsed light signals coming from measured particles. DC inputs are used to record continuous signals in the data list including, for example, laser power, temperature, or other externally varying parameters as described in Asbury et al., (1996), supra and are fed directly into A/D converters without baseline-restoration. For the measurements described in this example, the angle of the polarizer was voltage encoded and stored using one of the DC inputs.

The polarizer was attached to the flow cytometer as follows. A Glan-Taylor polarizer (03PTA401; Melles Griot, Irvine, Calif.) was mounted as shown in FIG. 3B into the center of a rigid wheel that could be rotated 260°. A rotary potentiometer in a voltage divider circuit produced a voltage signal that varied linearly (between 0 and 5 V) with the angle of the prism. Light passing through the polarizer was collected with a photomultiplier (H95746;Hamamatsu, Bridgewater, N.J.). Photomultiplier output current was amplified with a custom-built preamp before connection to one of the pulse inputs of the electronics as described in van den Engh et al., (1989) supra. Colored glass or interference filters were placed in front of the polarizer to select the appropriate fluorescence or scatter wavelengths.

For one experiment, data were collected by placing a 50% plate beamsplitter (03BTFOO7; Melles Griot) at 45° incidence in front of the polarizer. By convention, the plane of incidence for the beamsplitter is defined as that including the normal to the reflecting surface and the direction of the incident beam. P-polarized light refers to light polarized parallel to this plane of incidence and s-polarized refers to light polarized perpendicular to it. No beamsplitters were included in the detection path for any of the remaining experiments.

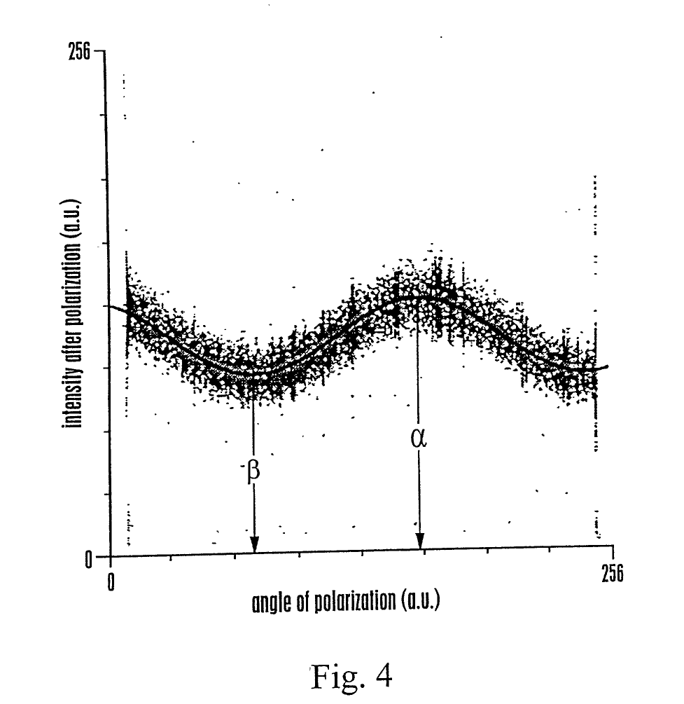

The measurement procedure and analysis were performed as follows. The sample consisted of fluorescent microspheres (Fluoresbrite YG, cat. no.18860; Polysciences, Warrington, Pa.) diluted 1:100 in distilled water prior to analysis. The polarizer was rotated manually during data acquisition. Both the angle of the polarizer and the light intensity collected after the polarizer were recorded for every measured particle. For each anisotropy calculation, a data list was collected including 40,000 particles distributed evenly over the 260° range of the rotating polarizer. A bivariate dot-plot of fluorescence intensity versus polarization angle for calibration beads is shown in FIG. 4 and demonstrates the sinusoidal variation predicted by Equation 2. A vertical slice through FIG. 4 at a given angle would reveal a distribution of intensities due to variation in particle brightness and to the overall precision limit of the system. In order to compress the raw data into a single curve, one intensity value was computed for each angle by taking the peak of the distribution after smoothing with a 10-channel sliding window. This process resulted in about 250 point pairs (angle xₙ, intensity Iₙ) summarizing the dataset.

The Levenberg-Marquardt method of nonlinear least squares fitting was used to compute the best-fit of Equation 2 to the point pairs. The Levenberg-Marquardt method of nonlinear least squares fitting has been described previously in Press et al., Numerical recipes in C: the art of scientific computing, 2^{nd} Ed., Cambridge University Press, Oxford (1992). Four adjustable parameters were included in the fit. Two were the coefficients of cos²_{η} and sin²_{η}, α and β, which were used to compute P. Two additional parameters, a gain and an offset, were used to calibrate the angle measurement by converting x in arbitrary units into η in degrees. New values for these two parameters were obtained each time the instrument was set up by measuring highly vertically polarized light and allowing the fitting routine to adjust all four parameters. For subsequent datasets, the same angle calibration could be used by keeping the gain and offset fixed and allowing the fitting routine to adjust only α and β. The point pairs and best-fit curves for each dataset were normalized by dividing intensities by (α+β) and plotted in polar coordinates.

Uncertainties in the fitted parameters α and β were calculated by assuming that intensities were normally distributed around the best-fit curve and using the chi-square value as a measure of the width of the normal distribution as described on page 661 of Press et al., (1992) supra. Uncertainties in P were then calculated by standard propagation of error.

This Example has demonstrated the dependence of detected intensity on polarization angle for both fluorescence and scatter produced by samples in a flow cytometer. The results indicate that equation 2 can be useful in determining a standard intensity value that can be compared between instruments having different configurations, for example, with respect to detection angle or polarizer angle.

### EXAMPLE II

### Selection of Laser-Blocking Filters

This example demonstrates the use of polarization measurements to determine laser-blocking efficiency of filters.

The accuracy of fluorescence polarization measurements depends on the extent to which laser scatter is blocked from the detector. Measured polarization values changed depending on laser-blocking efficiency of a series of long-pass filters. Specifically, measured polarization values were as follows: a 500LP filter, P=0.8; 520LP filter, P=0.28; 530LP filter, P=0.2; 550LP filter, P=0.2; and 488RB filter, P=0.2.

The 500LP through 550LP filters were purchased from Edmund Scientific (Barrington, N.J.) and the 488RB, rejection-band laser-blocking filter was purchased from Chroma Technology (Brattleboro, Vt.). Measurements were made with the flow cytometer conditions and analysis methods described in Example I. Calibration bead samples were prepared as described in Example I.

Using a long-pass 500LP filter, the apparent polarization of calibration beads was far above the theoretical limit for fluorescence, indicating that 488-nm laser scatter was leaking through the filter. In this case, the measured light was a super-position of scatter and fluorescence, resulting in a P value above 0.5 which is the theoretical limit for fluorescence. As filters were chosen with increasing (red-shifted) cut-on wavelengths, laser scatter was blocked more completely and measured values approached the true polarization of pure fluorescence from these beads. The 488RB filter blocked the laser very efficiently and had a very sharp cut-on at ˜495nm. Measurement with this filter gave the same P value as with the 550LP indicating that the 550LP effectively blocked detection of scattered laser light.

The results demonstrate that differences in polarization behaviors of scatter and fluorescence provide sensitive criteria with which to determine whether laser scatter leaks through a colored filter. The trend for longer (redder) cut-on wavelengths to give lower polarization is mostly due to differences in the laser-blocking efficiency of this series of filters, because polarization measured with the 488RB filter was the same as with the 550LP.

### EXAMPLE III

### Effects of Beamsplitters on Polarization Measurements

This example demonstrates that beamsplitters used in cytometry have transmissivities that depend strongly on the polarization state of the incident beam and on the orientation of the splitter with respect to the direction of polarization.

The effects of two different achromatic beamsplitters on polarization were investigated using fluorescence from calibration beads. Beamsplitters were found to produce orientation-dependent polarization artifacts. Comparison of polar plots of relative intensity versus polarization angle for bead fluorescence measured with and without a beamsplitter indicated that when a beamsplitter was placed in front of the polarizer at 45° incidence and oriented to reflect vertically, the transmitted light was more polarized than without the beamsplitter. With the beamsplitter oriented to reflect horizontally, the transmitted light was less polarized than without the beamsplitter and exhibited a negative polarization. The ratio of transmission of p-polarized to s-polarized light for the 45° beamsplitter was calculated to be Tₚ/Tₛ=1.64±0.05 using the data from the respective polar plots. A non-polarizing cube beamsplitter had a weaker effect on the transmitted light, but still showed some polarization sensitivity having Tₚ/Tₛ=1.12±0.03.

The plate beamsplitter transmitted p-polarized light 64% more efficiently than s-polarized light. Dichroic beamsplitters are known to have similar polarization sensitivity as evident from differences in the transmission and reflection spectra for p and s polarized light produced by commercially available dichroic beamsplitters. Chromatic properties of various dichroic beamsplitters are available from the respective manufacturers (Melles Groit, Irvine, Calif.; Chroma Technology Corp., Brattleboro, Vt.). A so-called non-polarizing beamsplitter cube (12106, Newport Corp, Irvine Calif.) exhibited a 12% difference in transmission between the s- and p-polarizations.

Measurements were made with the flow cytometer conditions and analysis methods described in Example I. Calibration bead samples were prepared as described in Example I.

These results demonstrate that one source of sensitivity to anisotropic radiation emission in a cytometer is beamsplitter orientation.

### EXAMPLE IV

### Fluorescence Polarization of Commonly Used Dyes

This example demonstrates that fluorescence polarization is a common phenomenon in flow cytometry.

The degree of polarization was determined for several commonly used dyes under normal conditions in a flow cytometer. The degrees of fluorescence polarization for these dyes are shown in Table 1.

TABLE 1
fluorescence polarization of thymocytes stained
with various dyes*

| Dye | Target | Concentration | | P |
|---|---|---|---|---|
| FDA | cytoplasm | 0.5 | μM | 0.191 ± 0.011 |
| CD4-FITC | cell surface | 1:200* | | 0.235 ± 0.016 |
| CD8-PE | cell surface | 1:100* | | 0.041 ± 0.015 |
| TO | DNA | 1.25 | μM | 0.281 ± 0.001 |
| EB | DNA | 1.3 | μM | 0.323 ± 0.002 |
| PI | DNA | 3 | μM | 0.336 ± 0.004 |
| TOTO | DNA | 1.5 | μM | 0.133 ± 0.002 |
| ETHD | DNA | 1 | μM | 0.278 ± 0.002 |
| YOYO | DNA | 1 | μM | 0.126 ± 0.001 |

*Dilutions are given for the labeled antibodies because absolute concentrations were unknown.

Significant polarization was exhibited by all dyes tested. The degree of fluorescence polarization from the surface marker anti-CD4-FITC and all the DNA-bound dyes was high (P≧0.25).

The high degree of polarization observed for DNA dyes is due to the rigidity and relative immobility of the large DNA molecules to which they are bound which hinders depolarization due to molecular movement. In addition to molecular movement, depolarization can occur through energy transfer. The lower polarization of dimeric DNA dyes (TOTO, ETHD, and YOYO) relative to monomeric dyes (TO, EB, and PI) indicate that intramolecular energy transfer occurs between the dimerized chromophores. Energy transfer can also be responsible for the very low polarization exhibited by the antibody-bound fluorophore, anti-CD8-PE, as compared to anti-CD4-FITC. These dyes are expected to have similar mobilities and fluorescence lifetimes, but unlike fluorescein (FITC), each PE molecule contains several closely linked fluorescent groups. Energy transfer can occur very readily between these groups.

Measurements were made with the flow cytometer conditions and analysis methods described in Example I. Samples were prepared as follows. Mouse thymocytes were harvested from B1O.PL(73NS)/Sn mice, centrifuged, and resuspended at ˜1×10⁶ cells/ml in Dulbecco's phosphate-buffered saline (PBS, pH 7.1, cat. no. 14080-055; Gibco BRL, Gaithersburg, Md.). The cytoplasmic dye, fluorescein diacetate (FDA, cat. no. 20164-2; Aldrich, Milwaukee, Wis.) was added, and the living cells were incubated for 30 min at 37° C. and analyzed immediately. For labeling CD4 and CD8 cell surface receptors, the thymocytes were incubated with fluorophore-conjugated antibodies in staining buffer (PBS with 0.05% sodium azide and 5% fetal bovine serum) for 1.5 h at room temperature, washed twice by centrifugation, and then fixed by addition of 1% formaldehyde. Antibodies conjugated to fluorescein (anti-CD4-FITC) and phycoerythrin (anti-CD8-PE) were purchased from Pharmingen (cat. nos. 09424D and 01045B; San Diego, Calif.). The thiazole orange derivative, TO-PRO-l iodide (TO), ethidium bromide (EB), propidium iodide (PI), TOTO-I iodide (TOTO), ethidium-homodimer-1 (ETHD), and YOYQ-1 iodide (YOYO) were incubated with thymocytes in PBS with added detergent (0.05% Triton-X to permeabilize membranes) and RNAse (50 pg/ml) for 30 min at room temperature prior to analysis. The DNA dyes were purchased from Molecular Probes (cat. nos. T-3602, E-3565, P-3566, T-3600, E-1169, and Y-3601; Eugene, OR). All procedures regarding the use of animals were approved by the Animal Care Committee at the University of Washington.

Throughout this application various publications have been referenced. The disclosures of these publications in their entireties are hereby incorporated by reference in this application in order to more fully describe the state of the art to which this invention pertains.

Although the invention has been described with reference to the examples provided above, it should be understood that various modifications can be made without departing from the spirit of the invention. Accordingly, the invention is limited only by the claims.

We claim:

1. A sample detection apparatus, comprising a polarized radiation source, flow chamber and signal detector, said flow chamber placed to contact polarized radiation from said polarized radiation source, said signal detector placed to selectively detect radiation propagated from said flow chamber at about 54.7 degrees from the direction of polarization of said contacted polarized radiation.

2. The sample detection apparatus of claim 1, comprising a trajectory of a sample stream that is orthogonal to said irradiation source.

3. The sample detection apparatus of claim 1, comprising a trajectory of a sample stream that is orthogonal to said signal detector.

4. The sample detection apparatus of claim 2, wherein said trajectory of said sample stream is parallel to said direction of polarization.

5. The sample detection apparatus of claim 4, wherein said signal detector is placed to selectively detect radiation propagated at about 54.7 degrees from a line parallel to said trajectory of said sample stream.

6. A flow cytometer, comprising a polarized radiation source, flow chamber and signal detector, said flow chamber placed to contact polarized radiation from said polarized radiation source, said signal detector placed to selectively detect radiation propagated from said flow chamber at about 54.7 degrees from the direction of polarization of said contacted polarized radiation.

7. The flow cytometer of claim 6, comprising a trajectory of a sample stream that is orthogonal to said irradiation source.

8. The flow cytometer of claim 6, comprising a trajectory of a sample stream that is orthogonal to said signal detector.

9. The flow cytometer of claim 7, wherein said trajectory of said sample stream is parallel to said direction of polarization.

10. The flow cytometer of claim 9, wherein said signal detector is placed to selectively detect radiation propagated at about 54.7 degrees from a line parallel to said trajectory of said sample stream.

11. A sample detection apparatus, comprising a polarized radiation source, flow chamber, signal detector and a trajectory of a sample stream that is orthogonal to said polarized radiation source and said signal detector, said polarized radiation source placed to contact said trajectory of said sample stream with polarized radiation, said polarization direction being 35.3 degrees from a line parallel to said trajectory of said sample stream.

12. A flow cytometer, comprising a polarized radiation source, flow chamber, signal detector and a trajectory of a sample stream that is orthogonal to said polarized radiation source and said signal detector, said polarized radiation source placed to contact said trajectory of said sample stream with polarized radiation, said polarization direction being 35.3 degrees from a line parallel to said trajectory of said sample stream.

13. A method of detecting fluorescent intensity for a sample in a flow cytometer independent of anisotropic radiation emission, comprising:
(a) contacting a sample in a flow cytometer with polarized radiation; and
(b) detecting radiation emitted by said sample at about 54.7 degrees with respect to the direction of polarization of said polarized radiation at the point of sample contact.

14. The method of claim 13, wherein said flow cytometer comprises a sample stream having a trajectory orthogonal to an irradiation source.

15. The method of claim 13, wherein said flow cytometer comprises a sample stream having a trajectory orthogonal to a detector.

16. The method of claim 14, wherein said flow cytometer comprises a sample stream having a trajectory orthogonal to a detector.

17. The method of claim 14, wherein said trajectory is parallel to said direction of polarization.

18. The method of claim 17, wherein the point of observation of a signal detector is placed about 54.7 degrees from a line parallel to said trajectory of said sample stream.

19. A method for determining scattered irradiation passing through a filter, comprising determining a degree of polarization through a filter, wherein said degree of polarization is greater than 0.5.
